(19) United States
(12) Patent Application Publication
(10) Pub. No.: US 2026/0155153 A1
(43) Pub. Date: Jun. 4, 2026

(54) Coding and decoding audio signal

(71) Applicant: Fraunhofer-Gesellschaft zur Förderung der angewandten Forschung e.V., München (DE)

(72) Inventors: Domenico TIZIANI, Erlangen (DE); Guillaume FUCHS, Erlangen (DE); Sanya TAYAL, Erlangen (DE); Martin MÜLLER, Erlangen (DE); Sebastian BOLTEN, Buckenhof (DE); Kacper SAGNOWSKI, Erlangen (DE)

(21) Appl. No.: 19/460,527

(22) Filed: Jan. 27, 2026

Related U.S. Application Data
(63) Continuation of application No. PCT/EP2024/071683, filed on Jul. 31, 2024.

(30) Foreign Application Priority Data
Aug. 1, 2023 (WO) PCT/EP2023/071332

(51) Int. Cl. G10L 19/12; G10L 19/00

(52) U.S. Cl. CPC G10L 19/12; G10L 2019/0013

(57) ABSTRACT

There is disclosed an apparatus for decoding an audio signal, comprising:
a coded signal reader reading coded information on prediction coefficients and coded information on at least one pulse;
a signal processor generating the generating the decoded audio signal from a decoded version of the prediction coefficients and a decoded pulse combination. The decoded audio signal is generated at a first sampling, implying, in one frame, a first plurality of sample positions having a first number of sample positions. The apparatus derives the decoded pulse combination from the coded information on the pulse and a second-sampling codebook. The second-sampling codebook contains a set of pulse combinations defined at a second sampling, implying, in the frame, a second plurality of sample positions having a second number of sample positions. The first plurality of sample positions is different from the second plurality of sample positions.

### CROSS-REFERENCE TO RELATED APPLICATIONS

This application is a continuation of copending International Application No. PCT/EP2024/071683, filed Jul. 31, 2024, which is incorporated herein by reference in its entirety, and additionally claims priority from International Application No. PCT/EP2023/071332, filed Aug. 1, 2023, which is also incorporated herein by reference in its entirety.

### TECHNICAL FIELD

The present techniques relate to encoding and decoding an audio signal, e.g. applied to encoders, decoders, methods for encoding or decoding, and non-transitory storage units that control the encoding or decoding. For example, the present techniques refer to mapping and/or resampling of innovative codebook.

### BACKGROUND

An audio coder (e.g. speech coder) is known which relies on a codebook (e.g. innovative codebook) to quantize the prediction residual e.g. from linear prediction (LP) and long time prediction (LTP). In particular for encoding prediction residual signals (e.g. excitation signals) it is possible to encode positions, magnitudes and signs of pulses, and to subsequently decode them.

Despite having been widely assimilated, some issues have been experienced.

For example, in some cases, it would be preferable to further reduce the number of bits of a bitstream.

Further, it is often difficult to adapt to a target bitrate. When encoding, it is often preferable to maintain the sampling rate of the inputted audio signal, and this renders difficult to change the bitrate.

A more articulated discussion is presented here below.

In speech coding with CELP an innovative codebook is used to quantize the prediction residual from linear prediction (LP) and long time prediction (LTP). In contrast to the coding of the LP, where the spectral envelope is coded on a per time-frame basis, parameters for LTP and residual are quantized for multiple parts of a frame, referred to as subframes. In the specific case of ACELP (Algebraic CELP, i.e. CELP with an algebraic and innovative codebook) where the innovative codebook is defined by algebraic codes, the temporal positions and signs of pulses within a given subframe are encoded. The parameters of these pulses are optimized during encoding by a least squares algorithm. While the number of theoretically possible positions of a given amount of pulses within a subframe is only determined by the subframe's length and the sampling rate, the algebraic coding procedure selects pulse configurations from a subset with a cardinality that is limited by the available bit budget.

In existing implementations of ACELP like in 3GPP EVS, different sampling rates are applied for different bitrates such that additionally available bits can be used for increased temporal resolution. Additional resolution, and with that more possible pulse positions, comes at the cost of a reduction in the number of encodable pulses. The present technique provides, inter alia, an algebraic coding scheme that allows for the positioning of pulses at a lower bitrate without reducing the number of total pulses by systematically excluding pulse positions.

For efficient residual codes, it is convenient and usual to encode a number of possible pulse positions that is equal to a power of 2. If the number of samples per frame is a multiple of a power of 2, this can be achieved by dividing a frame into the appropriate amount of subframes. This coding scheme has two drawbacks: First, it cannot be applied if the number of samples is not a multiple of a power of 2. Secondly, the bit consumption for both LTP parameters and residual code increases with increasing number of subframes.

The innovative CELP codebook is generally highly constrained. For example, in ACELP each subframe is divided into tracks of interleaving positions. The number of positions is usually the same for each track and multiple of 2 for convenience, complexity and optimal code as mentioned above. For example, for a 64-sample subframe, 2 tracks of 32 samples or 4 tracks of 16 samples can be designed. The codebooks are then designed to distribute the pulse budget equally or nearly equally among the tracks. An equal or nearly equal number of pulses per track is then achieved.

Therefore, for low bit rates, when the number of pulses is limited, the number of tracks is to be reduced, which may be impossible or complicated because it does not lead to equal track sizes or size of multiple of two. Another more pragmatic solution is to be reduce the sampling-rate of the speech coder CELP, which automatically reduces the number of possible positions. This is typically done for wideband or super broadband speech coding operating at bit-rates lower than 16 kbps or about, where the baseband CELP encoder only operates at 12.8 KHz. The drawbacks of reducing the internal sampling rate of the baseband coding is that the coded audio bandwidth of the baseband coder is then further limited and memories and buffers need to be resampled when switching from or to a higher bit rate.

Example of potential positions of individual pulses in the 2-pulses algebraic codebook using 2 tracks of 32 positions, for a 64 sample subframe:

| T | Pulse | Positions |
|---|---|---|
| 1 | 0 | 0, 2, 4, 6, 8, 10, 12, 14, 16, |
| | | 18, 20, 22, 24, 26, 28, 30, 32, |
| | | 34, 36, 38, 40, 42, 44, 46, 48, |
| | | 50, 52, 54, 56, 58, 60, 62 |
| 2 | 1 | 1, 3, 5, 7, 9, 11, 13, 15, 17, |
| | | 19, 21, 23, 25, 27, 29, 31, 33, |
| | | 35, 37, 39, 41, 43, 45, 47, 49, |
| | | 51, 53, 55, 57, 59, 61, 63 |

Example of potential positions of individual pulses in 4 pulses-bit algebraic codebook using 4 tracks of 64 positions, for a 64 sample subframe:

| Track | Pulse | Positions |
|---|---|---|
| 1 | 0 | 0, 4, 8, 12, 16, |
| | | 20, 24, 28, 32 36, 40, |
| | | 44, 48, 52, 56, 60 |
| 2 | 1 | 1, 5, 9, 13, 17, 21, |
| | | 25, 29, 33, 37, 41, |
| | | 45, 49, 53, 57, 61 |
| 3 | 2 | 2, 6, 10, 14, 18, 22, |
| | | 26, 30, 34, 38, 42, |
| | | 46, 50, 54, 58, 62 |
| 4 | 3 | 3, 7, 11, 15, 19, 23, |
| | | 27, 31, 35, 39, 43, |
| | | 47, 51, 55, 59, 63 |

An example is provided in FIG. 2, where a 64 samples frame is split in 4 interleaved tracks of 16 samples (circle, cross, diamond and star)

### SUMMARY

According to an embodiment, an apparatus for generating a decoded audio signal divided into a plurality of frames or subframes according to ACELP may have:
a coded signal reader configured to read at least, from a coded signal, coded information on prediction coefficients and coded information on at least one pulse;
a signal processor configured to generate the decoded audio signal from at least a decoded version of the prediction coefficients and a decoded pulse combination, or the processed version thereof, wherein the decoded audio signal is generated at a first sampling, the first sampling implying, in one frame or subframe, a first plurality of sample positions having a first number of sample positions;
wherein the apparatus is configured to derive the decoded pulse combination from the coded information on the at least one pulse and a second-sampling codebook, wherein the at least one second-sampling codebook contains a set of pulse combinations defined at a second sampling, the second sampling implying, in the frame or subframe, a second plurality of sample positions having a second number of sample positions, wherein the first sampling is different from the second sampling at least in that the first plurality of sample positions is different from the second plurality of sample positions,
wherein the second number of sample positions is smaller than the first number of sample positions, wherein the at least one second-sampling codebook is or includes an innovative codebook.

According to another embodiment, an apparatus for encoding an audio signal divided into a plurality of frames or subframes according to ACELP may have:
a signal processor configured to determine prediction coefficients and a prediction residual signal in time domain at a first sampling, the first sampling implying, in one frame or subframe, a first plurality of sample positions having a first number of sample positions;
a pulse information encoder configured to determine coded information on a selected pulse combination which represents the prediction residual signal, the selected pulse combination being one entry of at least one second-sampling codebook, wherein the at least one second-sampling codebook contains a set of pulse combinations defined at a second sampling, the second sampling implying, in the frame or subframe, a second plurality of sample positions having a second number of sample positons, wherein the first sampling is different from the second sampling at least in that the first plurality of sample positions is different from the second plurality of sample positions, wherein the second number of sample positions is smaller than the first number of sample positions; and
a coded signal writer configured to write at least a coded information on the prediction coefficients and the coded information on the selected pulse combination.

There is disclosed an apparatus for generating a decoded audio signal divided into a plurality of frames or subframes, comprising:
a coded signal reader configured to read at least, from a coded signal, coded information on prediction coefficients and coded information on at least one pulse;
a signal processor configured to generate the decoded audio signal from at least a decoded version of the prediction coefficients and a decoded pulse combination, or the processed version thereof, wherein the decoded audio signal is generated at a first sampling, the first sampling implying, in one frame or subframe, a first plurality of sample positions having a first number of sample positions;
wherein the apparatus is configured to derive the decoded pulse combination from the coded information on the at least one pulse and a second-sampling codebook, wherein the at least one second-sampling codebook contains a set of pulse combinations defined at a second sampling, the second sampling implying, in the frame or subframe, a second plurality of sample positions having a second number of sample positions, wherein the first sampling is different from the second sampling at least in that the first plurality of sample positions is different from the second plurality of sample positions.

There is disclosed an apparatus for encoding an audio signal divided into a plurality of frames or subframes, the apparatus comprising:
a signal processor configured to determine prediction coefficients and a prediction residual signal in time domain at a first sampling, the first sampling implying, in one frame or subframe, a first plurality of sample positions having a first number of sample positions;
a pulse information encoder configured to determine coded information on a selected pulse combination which represents the prediction residual signal, the selected pulse combination being one entry of at least one second-sampling codebook, wherein the at least one second-sampling codebook contains a set of pulse combinations defined at a second sampling, the second sampling implying, in the frame or subframe, a second plurality of sample positions having a second number of sample positons, wherein the first sampling is different from the second sampling at least in that the first plurality of sample positions is different from the second plurality of sample positions; and
a coded signal writer configured to write at least a coded information on the prediction coefficients and the coded information on the selected pulse combination.

There is disclosed a method for decoding an audio signal from a coded audio signal, comprising:
reading, from a coded signal, coded information on prediction coefficients and coded information on at least one pulse; and
generating at a first sampling a decoded audio signal from at least a decoded version of the prediction coefficients and a decoded pulse combination, or the processed version thereof, the first sampling implying, in one frame or subframe, a first plurality of sample positions having a first number of sample positions,
the method comprising deriving the decoded pulse combination from the coded information on the at least one pulse and a second-sampling codebook, wherein the at least one second-sampling codebook contains a set of pulse combinations defined at a second sampling implying, in the frame or subframe, a second plurality of sample positions having a second number of sample positions, wherein the first sampling is different from the second sampling at least in that the first plurality of sample positions is different from the second plurality of sample positions.

There is disclosed an audio encoding method for encoding an audio signal, comprising:
determining prediction coefficients and a prediction residual signal in time domain at a first sampling, the first sampling implying, in one frame or subframe, a first plurality of sample positions having a first number of sample positions;
determining coded information on a selected pulse combination which represents the prediction residual signal, the selected pulse combination being one entry of at least one second-sampling codebook, wherein the at least one second-sampling codebook contains a set of pulse combinations defined at a second sampling, the second sampling implying, in one frame or subframe, a second plurality of sample positions having a second number of sample positons, wherein the first sampling is different from the second sampling at least in that the first plurality of sample positions is different from the second plurality of sample positions; and
writing at least a coded information on the prediction coefficients and the coded information on the selected pulse combination.

There is disclosed a non-transitory storage unit storing instruction which, when executing by a processor, cause the processor to perform a method as above.

### BRIEF DESCRIPTION OF THE DRAWINGS

Embodiments of the present invention will be detailed subsequently referring to the appended drawings, in which:

FIG. 1 shows an example of an operating mode of an encoder.

FIG. 2 illustrates a subframe splits into tracks.

FIG. 3a shows an example of first operational step of an encoder.

FIG. 3b shows an example of second operational step of the encoder following the first operational step of FIG. 3a.

FIG. 4 shows an example of encoder.

FIG. 5 shows an example of operation of the encoder of FIG. 4.

FIG. 6 shows an example of operation of the encoder of FIG. 4.

FIG. 7 shows an example of decoder.

FIG. 8 shows an example of operation of the decoder of FIG. 7.

FIG. 9 shows an example of encoder.

FIG. 10 shows an example of decoder.

### DETAILED DESCRIPTION OF THE INVENTION

### Examples

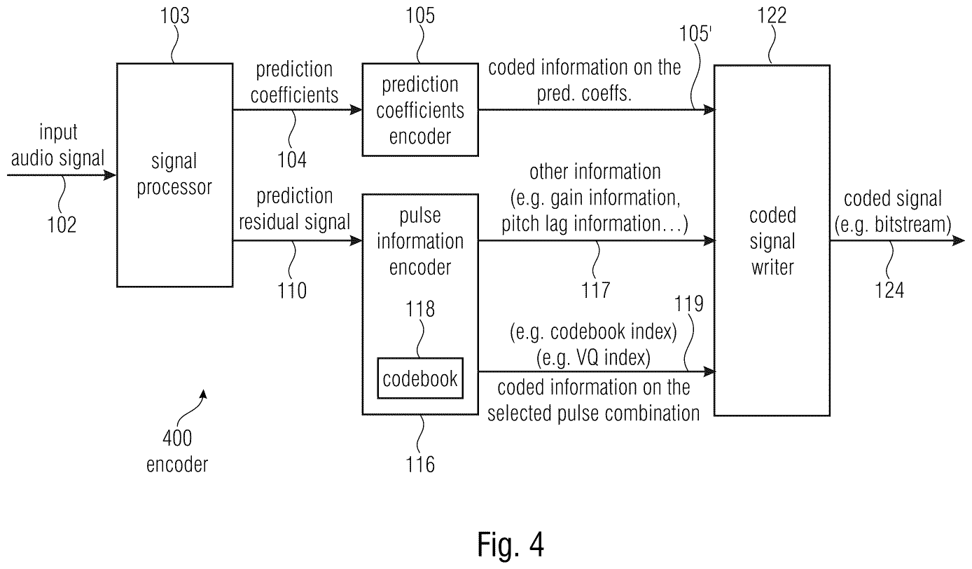

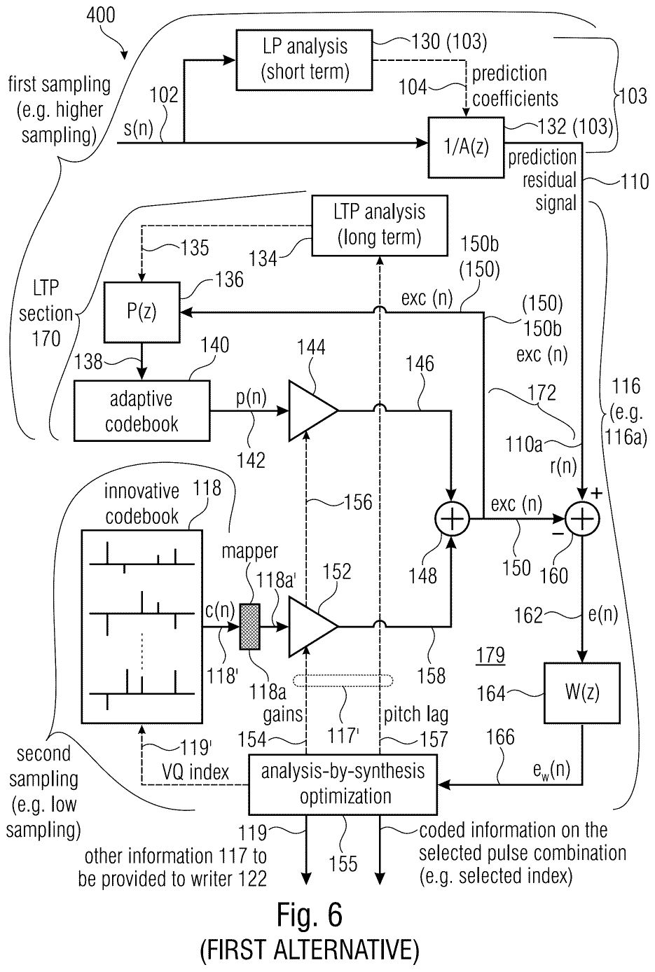

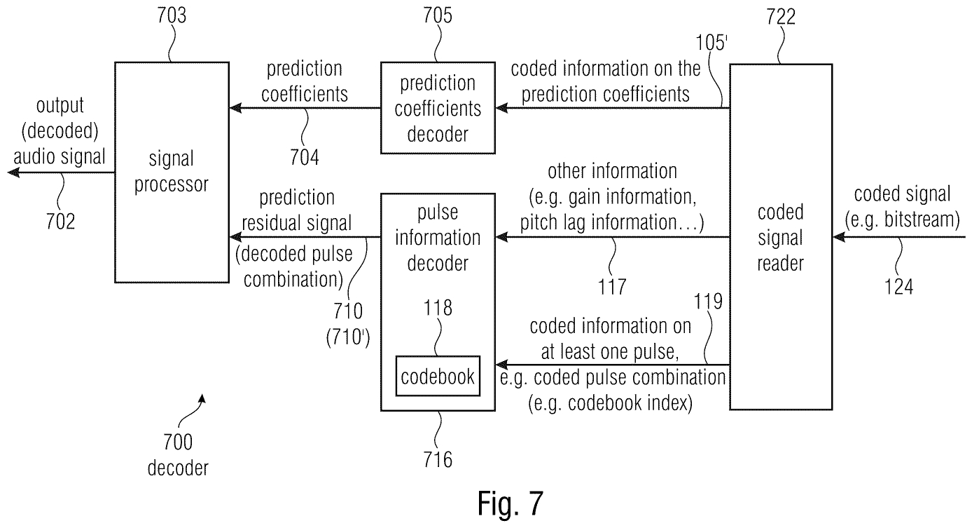

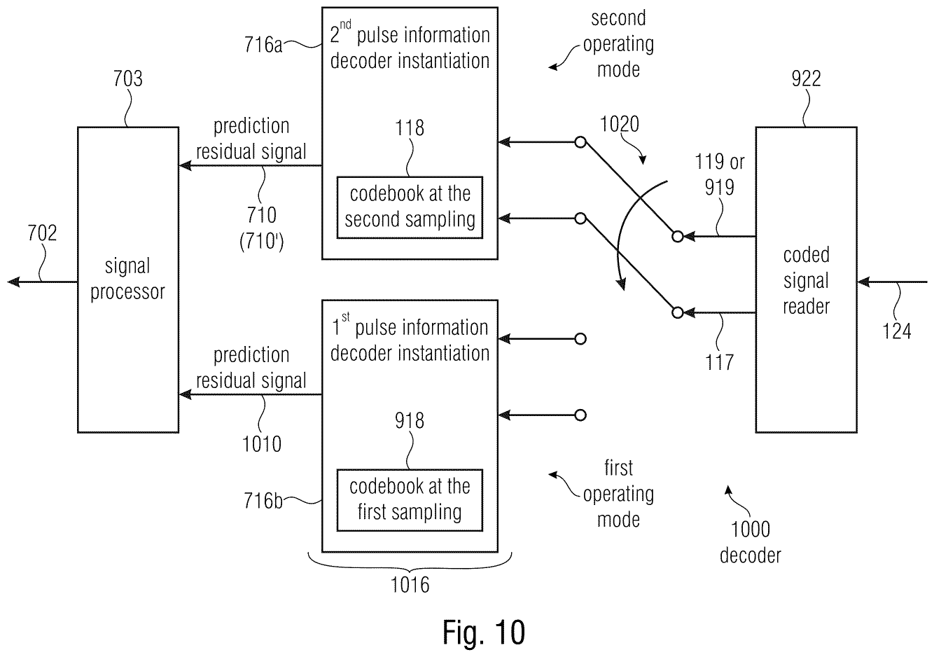

FIG. 4 shows an apparatus 400 (encoder) for encoding an input audio signal 102 (e.g. speech) onto a coded signal 124 (e.g., bitstream), e.g. according to CELP (in particular ACELP, i.e. CELP with an algebraic and innovative codebook). The encoder 400 may be a CELP encoder (e.g. CELP with an algebraic and innovative codebook). The encoder 400 may include a signal processor 103. The signal processor 103 may determine (e.g. through LP or LPC analysis) prediction coefficients 104 and a prediction residual signal (excitation) 110. The prediction coefficients 104 and the prediction residual signal 110 may be in time domain. The prediction coefficients 104 may be encoded, e.g., through a prediction coefficients encoder 105, onto coded information 105′ on the prediction coefficients 104. The prediction residual signal 110 may be provided to a pulse information encoder 116, which may include (or may be connected to) a codebook 118 (e.g. innovative codebook). The codebook 118 may be an algebraic codebook. The codebook 118 may be a priori known (e.g., the correspondence between the codebook entries and the particular pulse combinations may be known a priori). The codebook 118 may be the same used at the decoder (see below). The pulse information encoder 116 may provide coded information 119 on a selected pulse combination which represents the prediction residual signal 110. The coded information 119 on the selected pulse combination may be identified by one corresponding entry (e.g., one codebook index) of the codebook 118. The codebook 118 may contain a set of pulse combinations. The pulse information encoder 116 may therefore select, among the plurality of pulse combinations of the set of pulse combinations of the codebook 118, that pulse combination which best represents the prediction residual signal 110, e.g., minimizing an error (e.g. 162 in FIG. 6, see below) or a cost function, and may, therefore, provide coded information on the selected pulse combination as coded information 119. The coded information 105′ on the prediction coefficients 104 (or more in general any way of encoding a version of the prediction coefficients 104) as well as the coded information 119 on the selected pulse combination (representing the prediction residual signal 110) may be provided to a coded signal writer 122. The coded signal writer 122 may output the coded signal 124 (e.g., bitstream). The coded signal writer 122 may include an entropy encoder (but it may be avoided). The coded signal 124 may, therefore, be stored and/or transmitted to a receiving device which may comprise an apparatus for decoding the coded signal 124 (e.g. a decoder like the decoder 700 of FIG. 7 and the decoder 1000 of FIG. 10, see below).

The input audio signal 102 may be subdivided in a plurality of consecutive frames and/or subframes (e.g. one single frame may include more than one subframe). The input audio signal 102 may be provided at a first sampling. The first sampling may imply, on one frame or subframe, a first plurality of sampling positions (e.g. a set of sampling positions) having a first number of sampling positions (e.g. a first cardinality of the first set of sampling positions). Each sample of the input audio signal 102 may therefore be provided with a time domain value in each sampling position, according to the first sampling. For example, each frame or subframe may include the same first plurality of slots (e.g., 80 slots of the same time length, in 80 sample positions) and have a first number of sample positions (e.g., 80 sample positions). The first sampling may be associated, for example, to a first sampling rate (e.g. 80 samples per frame or subframe, e.g. 16 kHz in the case of the frame or subframe being 5 ms, i.e. 16000 samples per second).

However, the codebook 118 may be at a second sampling (and this is the reason why it may be called second-sampling codebook), different from the first sampling.

The second sampling may imply, in the same frame or subframe, a second plurality of sample positions (e.g. a second set of sample positions) having a second number of sample positions (e.g., 64 sample positions) different from the first number of sample positions (e.g. the cardinality of the second set may be less than the cardinality of the first set). The first sampling is different from the second sampling (e.g., the first plurality of sample positions may be different from the second plurality of sample positions and/or the first number of sample positions may be different from the second number of sample positions; for example, the first sampling may have a first sampling rate which is higher than the second sampling rate). Therefore, a frame or subframe of the input audio signal 102 and the prediction residual signal 110 may be at the first sampling (e.g., 80 samples for the frame or subframe) while the codebook 118 may be at the second sampling (e.g., the codebook 118 may output a pulse combination into 64 sample positions for the same frame or subframe). By providing coded information 119 on the selected pulse combination at the second sampling, the bitrate is reduced. Notably, the prediction coefficients 104 (or the processed version 105′) may be at the first sampling, but the prediction residual signal may be at the second sampling. In examples, the first sampling may imply a first sampling rate and the second sampling may imply a second sampling rate which is less than the first sampling rate (e.g., the first sampling rate may imply 80 sample positions per frame or subframe, while the second sampling may imply 64 sample positions per frame or subframe, or e.g. the first sampling-rate may imply 16 kHz while the second sampling-rate may imply 12.8 kHz).

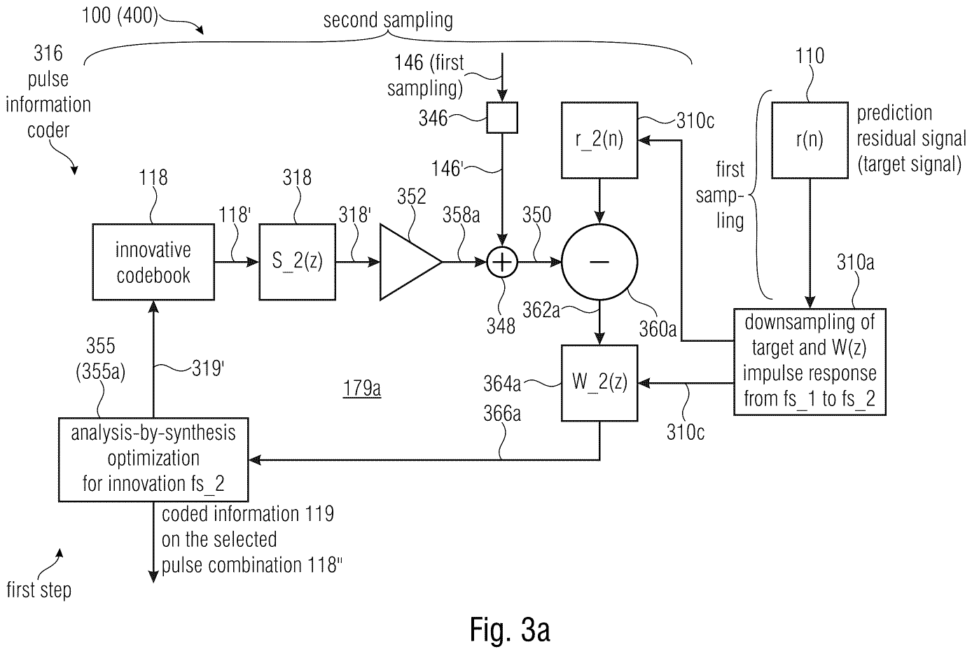

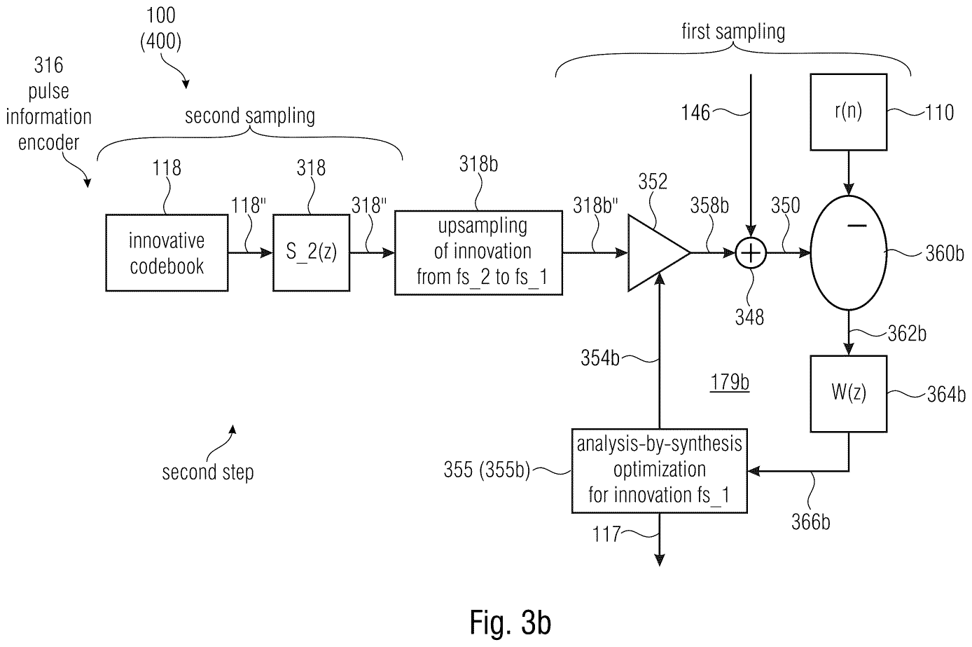

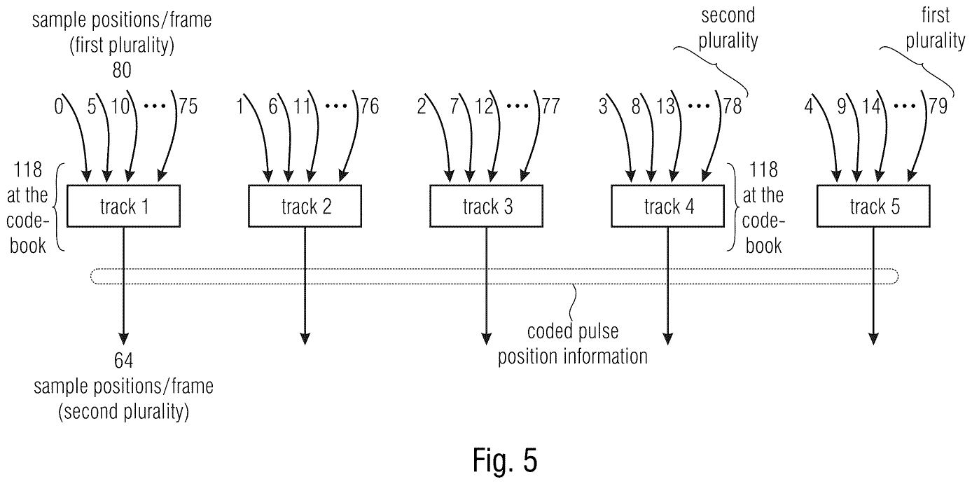

It will be shown later that in a first alternative (e.g. shown in FIGS. 5 and 6) a conversion from the first sampling to the second sampling is attained by ignoring some sample positions of the prediction residual signal 110, while according to a second alternative (e.g. shown in FIGS. 3a and 3b) a conversion from the first sampling to the second sampling is attained by resampling the prediction residual signal 110 or the codevector 118″ of the codebook 118, or a processed version of it (318″).

FIG. 6 shows a more detailed example of the encoder 400 according to the first alternative. Here, the input audio signal 102 is also mathematically indicated as s (n) (where n is the sample position according to the first sampling). The input audio signal 102 may be provided, for example, to an analysis block (short term prediction block) 130, which may be part of the signal processor 103. The LP analysis block 130 may output the prediction coefficients 104, which may be provided to the prediction coefficients encoder 105. The LP analysis block 130 may also control the LPC linear predictive coding analysis filter block 132 (which may also be part of the signal processor 103), which is mathematically indicated with 1/A(z). The LPC linear predictive coding analysis filter block 132 may output the prediction residual signal (excitation) 110. The prediction residual signal (excitation) 110 may be provided to the pulse information encoder 116. Then, the pulse information encoder 116 is in FIG. 6 indicated as including at least some of the blocks 118, 134, 136, 140, 144, 148, 152, 155, 160, 164. The prediction residual signal 110 (also mathematically indicated as r(n)) may be provided, through the line 110a, to an optimization section 172, whose task is to find out a pulse combination which best represents the prediction residual signal 110. In the optimization section 172, several candidate excitation signals 150 (indicated mathematically as exc(n)) are iteratively evaluated, to find out that candidate excitation signal which best represents the residual signal 110. As will be illustrated later, each candidate excitation signal 150 is obtained from two components, i.e. a predictive component 146 and an innovative component 158.

An input 150b (which, as explained below, is a past coded excitation 150, or processed version thereof) may be provided to the filter/delay block 136, expressed mathematically with P(z), for example of type P(z)=z^{-P}. The filter/delay block 136 may be controlled through long-term prediction parameter 135, corresponding to the lag P, given by a LTP analysis block 134. The LTP analysis block 134 may, for example, obtain a pitch lag 157, through which it outputs the long-term prediction parameter 135 which controls filter/delay block 136. Notably, the pitch lag 157 may be iteratively optimized (and several candidate pitch lags 157 may be attempted before finding out the most appropriated pitch lag). It's important to note that pitch lag can also have a fractional component, in which case the filter/delay P(z) is a filter composed of a delay of integer number of samples combined with interpolation, like a linear interpolation. The input 150b of the filter/delay block 136 is the past coded excitation 150, as reconstructed at both encoder side and decoder side. The output 138 of filter/delay block 136 may be provided to an adaptive codebook 140. The adaptive codebook 140 may output a component 142 (predictive signal, or predictive component of the candidate excitation signal 150), expressed mathematically as p(n). The output 142 (p(b)) of the adaptive codebook 140 may, once scaled by a gain 156 at a scaler 144, provide the predictive component 146 of the candidate excitation signal 150. The gain 156 for scaling the predictive signal p(n) 142 may be iteratively obtained, for example, by an analysis-by-synthesis 155 which will be discussed later, by cyclically trying multiple gains, and be evaluating the one which provides a best result. It is understood that the adaptive codebook 140 may contain past coded excitation vectors (excitation signals) so that the prediction signal 142 represents the prediction of the candidate excitation signal 150. Hence, the excitation signal 150 may be obtained by adding (at adder 148) the prediction component 146 obtained from the adaptive codebook 140 (taking into account the past excitations) with an innovative component 158 obtained from the innovative codebook 118. The innovative codebook 118 is the same indicated in FIG. 4. From the innovative codebook 118 the innovative component 158 of the candidate excitation signal is obtained and added, at adder 148, with the predictive component 146, to obtain the candidate excitation signal 150. It may be understood that, while the cycles 179 are performed, the excitation signal 150 is actually a candidate excitation signal, since it is necessary to evaluate the best excitation signal which best approximates the prediction residual signal 110. The candidate excitation signal 150 may be compared with the prediction residual signal 110 as obtained from the signal processor 103 (e.g., from block 132). Therefore, an error 162 (or more in general a cost function), expressed mathematically with e(n) may be obtained (e.g. as e(n)=abs (r(n)−exc(n)), where “abs” means the absolute value (and could also be written as e(n)=|r(n)−exc(n)|) but may be substituted by any other norm (e.g. e(n)=∥r(n)−exc(n)∥), and n is the sample position according to the first sampling). Ideally, the error 162 would be 0, but since this is in general not achievable, a technique for minimizing the error e(n) (162) is used by cyclically searching for the candidate excitation 150 which minimizes the error 162. The error 162 may be filtered at the weighting filter block 164, expressed mathematically as W(z). Therefore, a processed version of the error 166, indicated mathematically with e_{w}(n), is, therefore, obtained and provided to the analysis-by-synthesis optimization block 155, for evaluating the error e_{w}(n) among a plurality of other errors obtained in other iterations of the cycle 179. After having carried out the evaluation, the analysis-by-synthesis optimization block 155 may select a particular pulse combination which best represents the prediction residual signal 110, providing the coded information 119 on the selected pulse combination to the coded signal writer 122. The coded information 119 on the selected pulse combination is obtained iteratively or in another way by searching the pulse combination which minimizes the error 162 (166). This may be obtained, for example, through the iterations 179. Here, it is shown that the analysis-by-synthesis optimization block 155 provides indexes (entries) 119′ to the codebook 118. The codebook 118 outputs, for each candidate index 119′, a related candidate pulse combination 118′. Notably, the candidate pulse combination 118′ is at the second sampling, but is mapped, through a mapper 118a, onto a version 118a′ at the first sampling. The pulse combination 118a′ in the second sampling is scaled at a scaler 152, by a candidate gain 154 (which is controlled by the gain information, outputted by the analysis-by-synthesis optimization block 155). The scaled version 158 of the combination of pulses 118′ (118a′) may, therefore, be understood as another component (innovative component 158) of the candidate excitation signal 150. The analysis-by-synthesis optimization block 155 may, therefore, iteratively provide several candidate indexes 119′ to the codebook 118, so as to iteratively find out that pulse combination which, among all the candidate pulse combinations 119′ evaluated, minimizes the error 162 (166) from the prediction residual signal 110. It is important to note that the pulse combination 118a′ in the second sampling may be further processed by one or more filters or processors. For example, a format sharpening may be applied in accordance with a version or weighted version of the LPC coefficients. Pitch sharpening may also be applied as a function of the LTP parameter. Another possibility is to emphasize high frequencies, as taught in several ACELP implementations as in EVS.

It is noted that the past excitation signal 150b is not necessarily the same of the candidate excitation signal 150, but is the best excitation signal, among the candidate excitation signals 150, obtained for the previous frame or subframe.

Summarizing, the cyclical optimization (through the iterations 179) permits to find out the best candidate excitation signal 150 to approximate the prediction residual signal 110. Since the best candidate excitation signal 150 is associated to the particular candidate excitation predictive component 146 (associated to a particular gain 156 and a particular pitch lag 157) and the particular candidate excitation innovative component 158 (associated to a particular gain 154 and a particular codebook index 119′), it is possible to simply encode the parameters 156, 154, 156, and 119′ associated to the best approximating excitation signal 150 in the coded signal 124.

According to the first alternative, the input audio signal 102, the prediction residual signal 110 and the excitation predictive component 146 and the excitation innovative component 158, as well as the excitation 150 and the error 162 (also in its version 166) are according to the first sampling (e.g., 80 samples per frame or subframe). However, the candidate indexes 119′ are at the second sampling (e.g., second, lower number of sample positions per frame or subframe) as well as the codebook 118 operates at the second sampling, and the candidate pulse combination 118′ is also at the second sampling. The mapper 118a maps the candidate pulse combination 118′ from the second sampling (e.g., 64 samples per frame or subframe) on the version 118a′ of the candidate pulse combination 118′ in the first sampling (e.g., 80 samples per frame or subframe). Preferably, the scaler 152 is at the first sampling (e.g., higher sampling, e.g., 80 sample positions per frame or subframe).

It is here explained how, according to the first alternative, to reduce the sampling from the first sampling (e.g. a first plurality of samples positions per frame or subframe, e.g. in a first number which may be, for example, 80) to the second sampling (e.g. a second plurality of samples positions per frame or subframe, e.g. in a second number which may be, for example, 64). In each frame or subframe, each single sample position may be numbered: for example, the first sample position may be indicated with 0, the second sample position (e.g. temporally immediately successive to the first sample position) may be indicated with 1, the third sample position (e.g. temporally immediately successive to the second sample position) may be indicated with 2, the fourth sample position (e.g. temporally immediately successive to the third sample position) may be indicated with 3, the fifth sample position (e.g. temporally immediately successive to the fourth sample position) may be indicated with 4, the sixth sample position (e.g. temporally immediately successive to the fifth sample position) may be indicated with 5, the seventh sample position (e.g. temporally immediately successive to the sixth sample position) may be indicated with 6, the eighth sample position (e.g. temporally immediately successive to the seventh sample position) may be indicated with 7, the ninth sample position (e.g. temporally immediately successive to the eighth sample position) may be indicated with 8, the tenth sample position may be indicated with 9, . . . the 76^{th} sample position may be indicated with 75, the 77^{th} sample position may be indicated with 76, the 78^{th} sample position may be indicated with 77, the 79^{th} sample position may be indicated with 78, and the 80^{th} sample position may be indicated with 79.

| Track | Pulses | Sample Positions |
|---|---|---|
| 1 | 0, 4 | 0, 5, 10, 15, 20, 25, |
| | | 30, 35, 40, 45, 50, |
| | | 55, 60, 65, 70, 75 |
| 2 | 1, 5 | 1, 6, 11, 12, 21, 26, |
| | | 31, 36, 41, 46, 51, |
| | | 56, 61, 66, 71, 76 |
| 3 | 2, 6 | 2, 7, 12, 17, 22, 27, |
| | | 32, 37, 42, 47, 52, |
| | | 57, 62, 67, 72, 77 |
| 4 | 3, 7 | 3, 8, 13, 18, 23, 28, |
| | | 33, 38, 43, 48, 53, |
| | | 58, 63, 68, 73, 78 |
| 5 | No | 4, 9, 14, 19, 24, 29, |
| | pulse | 34, 39, 44, 49, 54, |
| | | 59, 64, 69, 74, 79 |
| | | (excluded in the second sampling) |

Further, as shown in the table here above, the first plurality of samples is defined according to a plurality of tracks (e.g. tracks 1, 2, 3, 4, and 5), which may be regularly interleaved with each other. For example, the track 1 includes the first sample position 0, the sixth sample position 5, . . . and the 76^{th} sample position 75; the track 2 comprises the second sample position 1, the seventh sample position 6, . . . and the 77^{th} sample position 76; and the track 5 comprises the fifth sample position 4, the tenth sample position 9 . . . and the 80^{th} sample position 79. Each sample position of each track, therefore, immediately precedes a sample position of the immediately subsequent track and follows a sample position of the immediately preceding track (the samples of track 5 are followed by the samples of track 1). For each track, there may be application-specifically defined a predefined number of pulses. Here, it is indicated that each of the tracks 1, 2, 3, and 4 may have two pulses. According to the particular aspect, at least one track (in this case track 5) is a void track which has no pulse at all. For this reason, in case there are, application-specifically, two pulses per track, there can be only eight pulses and only in the sample positions of the tracks 1, 2, 3, and 4, but no sample position is admitted to host a pulse in track 5 (more in general, the second plurality of sample positions may be a proper subset of the first plurality of sample positions). Therefore, the sample positions 5, 9, 14 . . . and 79 cannot host any pulse. The tracks 1, 2, 3, 4 and 5 are tracks that all concur to form the first plurality of 80 sample positions at the first sampling, while tracks 1, 2, 3, and 4 (but not track 5) are the tracks that concur to form the second plurality of samples in the second sampling. While the tracks that form the first plurality of sampling are considered in the signals 102, 160, 150, 146, 158, 162, 166 (and all their sample positions are occupied by some values), the excluded tracks (void tracks) do not form the second plurality of samples (and their sample positions don't host any value, or host values which are ignored).

The candidate index 119′ (which is iteratively provided by the analysis-by-synthesis optimization block 155 to the innovative codebook 118) has information only on the first plurality of sample positions (e.g. tracks 1, 2, 3, and 4), but carries no information on the fifth track (equivalently, it may be said that the codebook 118 ignores the track 5, even in the case of the track 5 being provided to the codebook 118). Hence, the innovative codebook 118 provides a candidate pulse combination 118′ which lacks the sample positions of the track 5. Basically, the innovative codebook 118 ignores the track 5. In examples, the mapper 118a may map the second plurality of sample positions (i.e. tracks 1, 2, 3, and 4) onto a version in the first plurality of sample positions by adding samples at the sample positions of the void track 5 (e.g., zero-valued samples). Therefore, the version 118a′ of the candidate pulse combination 118′ is an upsampled version in the first sampling of the candidate pulse combination 118′. In examples, however, there are no pulses in the sample positions of the void track 5, since in general the added sampling positions have value 0. Subsequently, the first-sampling version 118a′ of the candidate pulse combination 118′ is scaled by a candidate gain 154 (according to the gain information provided by the analysis-by-synthesis optimization block 155), to obtain the innovative component 158 of the excitation 150.

FIG. 5 shows conceptually the operations of passing from the first plurality of sample positions (tracks 1, 2, 3, 4 and 5) to the second plurality of sample positions.

It is to be noted that the second number of sample positions is preferably a power of 2 (e.g. 2^{N}, where N is a positive integer, e.g. 64), and the difference between the first number of sample positions (e.g. 80) and the second number of sample positions (e.g. 64) may be also a power of 2 (e.g., 2^{M}, where M is a positive integer smaller than N, e.g. 16). More in general, also the length of each track is preferably an integer power of 2. Such a characteristic makes it easy to design the coding of the pulse positions into a binary format, and the so-obtained coding is usually quasi-optimal or even optimal in the mathematical sense, and moreover low-complex. Such a coding scheme is also very often already available in a given system. In the latter case, the invention makes possible to reuse an existing coding scheme for a new advantageous combination of bit-rate and sampling used for the CELP, without having to redefine or redesigned the pulse position coding.

It could be imagined that, by simply discarding one or more tracks from the first plurality of samples, a worse approximation of the prediction residual signal 110 by the candidate excitation 150 would be caused, thereby decreasing the quality of the encoding. However, it has been experienced that the quality reduction is not dramatic, but the savings in terms of bitrate are favorable. This same bitrate saving can advantageously be reinvested in allowing more pulses or coding less coarsely other coding parameters

Examples of encoders according to the second alternative are here discussed. FIGS. 3a and 3b show another example of apparatus 400 (here specifically indicated as 100) for encoding the audio signal 102. Here, elements 130 and 132 (103), as well as elements 134, 136, 140, and 144 are not shown, but they can be taken from FIG. 6. In this case, there are two cyclical steps 179a (illustrated in FIGS. 3a) and 179b (illustrated in FIG. 3b). FIG. 3a shows an example of the first step which is carried out by the encoder 100, while FIG. 3b shows an example of the second step which is carried out after having carried out the first step. FIG. 3a shows that the prediction residual signal 110 (target signal), indicated mathematically with r(n), is downsampled at block 310a, thereby passing from the first sampling (e.g. 80 sample positions per frame or subframe) to the second sampling (e.g. 64 sample positions in the same frame or subframe). The downsampling at block 310a therefore permits to obtain a downsampled version 310c (indicated mathematically with r_2(n)) of the prediction residual signal 110. Here, the candidate excitation signal is indicated at 350 and is compared with the downsampled version 310c of the prediction residual signal 110. Similarly to the first alternative of FIG. 6, the candidate excitation signal 350 is obtained, through adder 348, from a downsampled version 146′ of the excitation prediction component 146 and a candidate innovative component 358a obtained from the innovative codebook 118 (the innovative codebook 118 can be the same of the first alternative, and therefore we use the same reference number). The excitation predictive component 146 may be downsampled, for example, at a downsampler 346. It is noted that the cycle 179a which is used in the first step (FIG. 3a) has all the components at the second sampling.

It can be seen, that the downsampled version 310c of the prediction residual signal 110 may be subjected to a weighting filter W_2(z) at block 364a. The input of the block 364a may be the result 362a (error) of the comparison (at 360a) between the candidate excitation signal 350 and the downsampled version of the innovative component 358a).

The filtered signal 366a is provided to an analysis-by-synthesis block 355 which is here instantiated as instance 355a (first-step instance). The block 355 (instance 355a) defines a plurality of indexes 319′ cyclically inputted to the innovative codebook 118 (in the second, lower sampling). The innovative codebook 118 cyclically outputs, based on its input 319′, a candidate pulse combination 118′. Optionally, the candidate pulse combination 118′ may be filtered by a filter or a series of filters 318, expressed mathematically by S_2(z), to obtain a filtered version 318′ of the candidate pulse combination 118′. The filter or the series of filters may be associated to a specific frequency shaping of the candidate pulse combination, like a format sharpening and/or a pitch sharpening, The filtered version 318′ of the candidate pulse combination 118′ is then, in the cycle 179a of the first step, provided to a scaler 352. The output 358a of the scaler 352 (which is the candidate innovative component of the candidate excitation 350), operated at the second sampling (based on the second sampling rate fs_2), may be inputted to the adder 348, to be added to the predictive component 146′ of the candidate excitation 350. In this case, the gain used at the scaler 352 is a predefined optimal gain, which is not changed by the analysis-by-synthesis block 355 (instantiation 355a) during the iterations of the first cycle 179a. Therefore, the best pulse combination 118″ (among all the combinations 118′ or 318′) is found, which minimizes the error 362a. Accordingly, the coded information 119 on the selected pulse combination 118″ (informing of the pulse combination 118″ which permits to obtain the best approximation 350 of the prediction residual signal 110 in the second sampling) may be provided to the coded signal writer 122.

Once the first step is concluded (i.e., when the selected pulse combination which minimizes the error 362a or 366a is retrieved), it is possible to trigger the second step (FIG. 3b). Here, a second cycle 179b is iterated, where processing is performed at the first sampling (e.g. higher sampling associated to the first, higher sampling rate fs_1). As can be seen, the innovative codebook 118 now provides the selected pulse combination 118″, (which may be, for example, filtered at filter block 318, expressed mathematically as S_2(z) and providing the filtered selected pulse combination 318′. At this point, the selected pulse combination 118″ (either in the version 118″ or in the version 318″) may be upsampled at upsampling block 318b. Therefore, an upsampled version 318b″ of the selected pulse combination 118″ (or is filtered version 318′) may be provided to the scaler 352. The scaler 352 may provide a candidate innovative component 358b of the candidate excitation signal 350. In order to arrive at the candidate excitation 350, at the adder 348, the predictive version 146 of the candidate excitation signal 350 is provided at the first sampling. Even in this case, through cycle 179b of second step (FIG. 3b), while the preferred pulse combination 118″ (318′) is already obtained, it is only searched for the optimal gain to be provided to the innovative component 358b of the candidate excitation signal 350. Here, reference numeral 354b indicates a gain control exerted on the scaler 352, so as to retrieve the gain (from a candidate gain indicated by the control 354b) which permits to best approximate the prediction residual signal 110. At comparison block 360b, there is compared the prediction residual signal 110 (target signal) with the candidate excitation signal 350 and the error 362b can be evaluated by the analysis-by-synthesis block 355 (in its second instantiation 355b) (here, a weighting filter 364b is shown to provide a weighted version 366b of the error 362b to the analysis-by-synthesis block 355). Analogously, even if not shown, the analysis-by-synthesis optimization block 350 (in the second instantiation 355b) may provide the gain 156 for the predictive component 146 of the candidate excitation signal 350 and the pitch lag. Therefore, the other information 117 can be provided to the coded signal writer 122 (e.g. gain information, pitch lag information and so on).

It is noted that it is possible to downsample (at 310a) the prediction residual signal (110) in time domain. This is advantageous, because the prediction residual signal (110) is already in time domain. For example, block 310a may perform a linear phase filter.

In alternative, at block 310a it is possible to first convert the prediction residual signal 110 into frequency domain (e.g. using the time-frequency block transform like short-time Fourier transform STFT, fast Fourier transform FFT, discrete cosine transformation DCT, or similar line transformation), downsample the frequency-domain version of the prediction residual signal 110 in frequency domain (e.g. using a block transform without any overlapping between adjacent blocks and/or a block transform using spectrum truncation or more in particular using a spectrum truncation or a constant scaling), and then to reconvert the downsampled frequency-domain version of the prediction residual signal 110 onto the time domain (e.g. using the inverse time-frequency block transform like inverse short-time Fourier transform ISTFT, inverse fast Fourier transform IFFT, inverse discrete cosine transformation IDCT, or similar inverse line transformation.

In general terms, it is possible (e.g. in FIG. 3a) to downsample (e.g. at 310a) the prediction residual signal (110) or the processed version thereof, and/or to upsample (e.g. in FIG. 3b at 318b) the selected combination of pulses (e.g. 118″), or the processed version (e.g. 318″) thereof, in time domain using a linear phase filter.

It is possible (in FIG. 3a) to convert the prediction residual signal (e.g. 110) or the processed version thereof, or (in FIG. 3b) the selected combination of pulses (e.g. 318′), or the processed version (e.g. 318″) thereof, into frequency domain and downsample (e.g. at 310a) the prediction residual signal (e.g. 110) or the processed version thereof, and/or (e.g. in FIG. 3b) upsample (e.g. in FIG. 3b at 318b) the selected combination of pulses (e.g. 118″), or the processed version (e.g. 318″) thereof, in frequency domain

It is possible (e.g. in FIG. 3a) to downsample (310a) the prediction residual signal (110) or the processed version thereof, and/or (e.g. in FIG. 3b) to upsample (e.g. at 318b in FIG. 3b) the selected combination of pulses (e.g. 118″) or the processed version (e.g. 318″) thereof in frequency domain by using a time-frequency block transform like short-time Fourier transform STFT, fast Fourier transform FFT, discrete cosine transform DCT, or similar line transformation.

It is possible (e.g. in FIG. 3a) to downsample (310a) the prediction residual signal (110) or the processed version thereof, and/or (e.g. in FIG. 3b) to upsample (e.g. at 318b in FIG. 3b) the selected combination of pulses (e.g. 118″) or the processed version (e.g. 318″) thereof in frequency domain using a block transform without any overlapping between adjacent blocks.

It is possible (e.g. in FIG. 3a) to downsample (310a) the prediction residual signal (110) or the processed version thereof, and/or (e.g. in FIG. 3b) to upsample (e.g. at 318b in FIG. 3b) the selected combination of pulses (e.g. 118″) or the processed version (e.g. 318″) thereof in frequency domain using a block transform using zero padding of the spectrum.

It is possible (e.g. in FIG. 3a) to downsample (310a) the prediction residual signal (110) or the processed version thereof, and/or (e.g. in FIG. 3b) to upsample (e.g. at 318b in FIG. 3b) the selected combination of pulses (e.g. 118″) or the processed version (e.g. 318″) thereof in frequency domain to upsample the selected combination of pulses or the processed version thereof in frequency domain using a constant scaling.

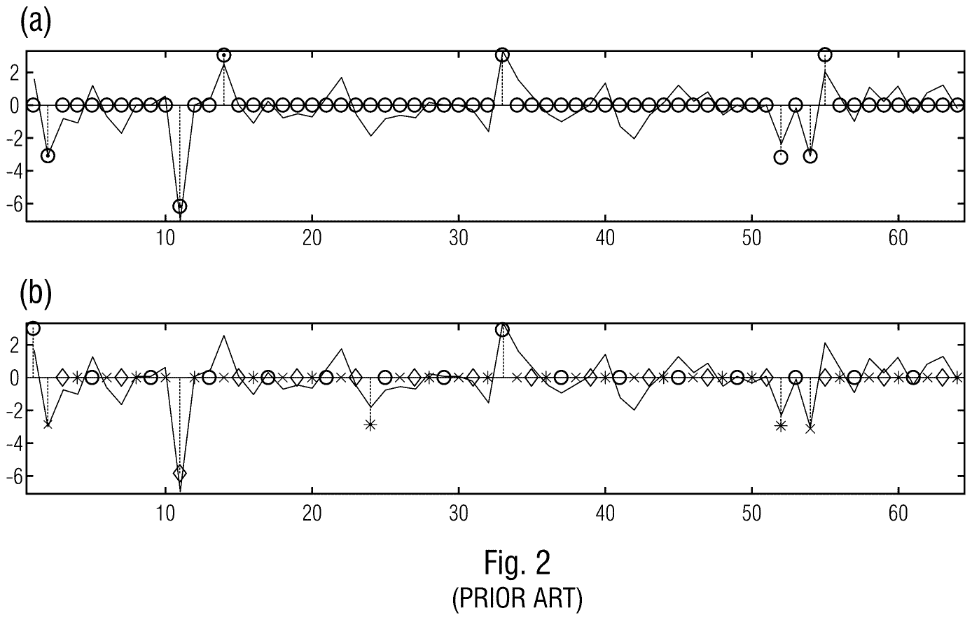

It is to be noted that, while in the first alternative of FIGS. 2, 5, and 6 the second sampling is obtained by subtracting one or more interleaved tracks from the first plurality of samples, the second alternative of FIGS. 3a and 3b foresees a real downsampling of the prediction residual signal 110 from the first sampling to the second sampling to search for the best pulse combination, but the gains and the pitch lag may be searched at the first sampling. As it can be seen, however, the codebook 118 remains in the second sampling rate.

It is noted that, in FIG. 3b, the sequence of the blocks 118, 318 and 318b may be skipped: for example, a second codebook (now shown) could be used which translates each pulse combination 118′ onto an upsampled pulse 318b″, and that upsampled pulse 318″ may be inputted onto the scaler 352 instead or actively proceeding with the filtering at 318 and the upsampling at 318b.

An alternative which appears to be less promising could be to avoid the second step of FIG. 3b, but (in FIG. 3a) directly upsampling the candidate pulse combination 118′ upstream to the scaler 352, and to simultaneously find the gain 354b to be applied to the scaler 352 in the same cycle 179a of FIG. 3a in the first sampling. This solution, which could also be carried out, is notwithstanding less preferred because the two-step technique of FIGS. 3a and 3b greatly reduces the complexity.

Summarizing, the encoder 100 (400) according to the first or second alternative may encode, in the encoded audio signal:
Coded information 119 on the selected pulse combination (e.g. 118″), in such a way that the decoder will be able to reconstruct the selected pulse combination from the coded information 119; and/or
Other information 117, e.g. including at least one of
   Gain information on the gain 154 to be applied to the selected pulse combination (e.g. 118″), once the decoder will have reconstructed the selected pulse combination;
   Gain information on the gain 156 to be applied to the excitation predictive component (142, 146) (the excitation predictive component will be estimated for example using an adaptive codebook); and
   Pitch lag information on the pitch lag 157, so that the decoder will be able to perform an LTP synthesis.

As can be seen in the two alternatives above:
In the first alternative (FIGS. 5 and 6), it is preferable (but not necessarily strictly requested) to iteratively search the pulse combination by, at each iteration:
   Generating each candidate pulse combination 118′ in the second sampling,
   Subsequently, at the same iteration, converting the candidate pulse combination 118′ onto a version 118a′ in the first sampling;
   At the same iteration, but in the first sampling, using a candidate gain 154, 156, and a candidate pitch lag 157;
   Evaluating the error 162 (166) of the candidate excitation 150 in the first sampling in the iteration;
   Repeating new iterations varying the candidate pulse combinations 118′ in the first sampling and the different candidate gains 154, 156, and candidate pitch lags 157 in the second sampling, up to the point that the best approximating excitation 150 is obtained;
   encoding the information 119 on the best candidate pulse combination as the selected pulse combination, and other information 117 including the best candidate gains 154, 156, and the best pitch lag 157.
In the second alternative (FIGS. 3a and 3b), it is it is preferable (but not necessarily strictly requested) to iteratively search the pulse combination by:
   Performing a first cycle (first step in FIG. 3a), in which, along a plurality of iterations 179a (and using predefined fixed values for the gains and the pitch lag), the best candidate pulse combination 118″ is recognized which permits to generate a best-approximating candidate excitation signal 350 in the second sampling;
   Performing a second cycle (second step in FIG. 3b), in which, along a plurality of iterations 179b (and using predefined fixed values for the gains and the pitch lag), an upsampled version 318b″ (in the first sampling) of the best candidate pulse combination 118″ is used, while different gains 354b, 156, and pitch lags 157 are searched for finding those gains and pitch lag which permit to obtain the candidate excitation signal 350 best approximating the prediction residual signal 110 in the first sampling;
   encoding the information 119 on the best candidate pulse combination 118″ as the selected pulse combination, and other information 117 including the best candidate gains 154, 156, and the best pitch lag 157.

FIG. 7 shows an example of an apparatus 700 (decoder) for generating a decoded audio signal 702 from a coded signal 124 (e.g. bit stream), for example in accordance with CELP (in particular ACELP, e.g. CELP with an algebraic and innovative codebook). The apparatus 700 may be a CELP decoder, the decoder being e.g. ACELP. The coded signal 124 is indicated with the same number of the coded signal 124 of FIG. 4 because it is imagined that the decoder 700 decodes the coded signal 124 generated by the encoder 400 (in any of the alternatives of FIGS. 3a, 3b, 5 and 6). It is not withstanding not strictly requested that the coded signal 124 is generated by an encoder and 700. The decoder 700 generates an output audio signal 702 in such a way that it is an audio representation as most trustful as possible of the input audio signal 102.

The decoder 700 may include a coded signal reader 722 which may read the coded signal 124. The coded signal reader 722 may include, for example, an entropy decoder (but this is not strictly required). The coded signal reader may provide coded information 105′ on prediction coefficients. The coded information 105′ on the prediction coefficients may be provided to a prediction coefficients decoder 705. The prediction coefficient decoder 705 may provide prediction coefficients 704 from the coded information 105′ on the prediction coefficients. The prediction coefficients 704 may be provided to a signal processor 703 to generate the output audio signal 702.

The coded signal reader 722 may read, from the coded signal 124, a coded pulse combination 119 (which may be the same of the coded information 119 on the selected pulse combination generated by the pulse information encoder 116 on the encoder 100, 400, and therefore the same reference numeral is used). The coded signal reader 722 may also read other information 117. The other information 117 may include, for example, other gain information (such as, for example, the other information 117 which may, for example, include gain information 154, 156 as obtained by operating the techniques of FIGS. 6 and 3b, for example) and/or pitch lag information (which may also be obtained as the pitch lag information 157 of FIGS. 6 and 3b, for example). The coded pulse combination 119 may be coded information on at least one pulse (but, more frequently, on a plurality of pulses). The coded pulse combination 119 may be in the form of a codebook index (such as the selected codebook index which minimizes the error in FIGS. 6 and 3a). The coded pulse combination 119 (and, optionally, the other information 117) may be provided to a pulse information decoder 716. The pulse information decoder 716 may provide prediction residual signals 710. The pulse information decoder may provide the prediction signal 710 by making use of an innovative codebook 118. The innovative codebook 118 may be the same as the innovate codebook 118 of the apparatus 100 or 400. In examples, the coded information 119 on the at least one pulse may be an entry of the codebook 118, so that the codebook 118, in turn, provides at least one pulse (or a coded pulse combination) 118′ pre-associated to the entry. The pulse information decoder 716 may therefore generate the prediction residual signal 710 from the coded information 119 on the at least one pulse, e.g., using also the other information 117 (gain information, pitch lag information and so on). The prediction residual signal may be provided to the signal processor 703. The signal processor 703 may generate the output audio signal 702 based on the prediction coefficients 704 and the prediction residual signal 710, e.g. by using LP synthesis technique.

As explained for the encoder 400 of FIG. 4, the signal to be represented (i.e., from its coded version 124 towards the audio signal 702) may be subdivided into frames and/or subframes. As also explained above, each frame or subframe may be, in turn, subdivided according to a first sampling and a second sampling. According to the first sampling, the frame or subframe is subdivided into a plurality of immediately adjacent sample positions (which are in a first number). According to the second sampling, the same frame or subframe is divided according to a second plurality of immediately adjacent sample positions (time slots) which are in a second number. The first sampling and the second sampling are here described exactly as for the encoder, because they are the same concept. The first sampling is different from the second sampling (e.g., the first sampling may have more sample positions than the second sampling for the same frame or subframe). As explained above for the encoder 400 or 100, the coded information 119 on the selected pulse combination is defined using the second sampling. This is maintained in the decoded information 710 on the at least one pulse at the second sampling. The pulse information decoder 716 may, therefore, provide the prediction residual signal 710 to be in the first sampling. It is reminded that, according to many examples, the first sampling may be understood as indicating a first sampling rate (e.g. 16 kHz) which is higher than the second sampling rate (which is the sampling rate of the second sampling) (e.g. 12.8 kHz), or anyway that there are more sample positions in the first sampling than in the second sampling for the same frame or subframe. Therefore, the output audio signal 702 (and more in general the prediction coefficients 704 and the prediction residual signal 710) are at the first sampling, despite the fact that the coded information 119 on the at least one pulse is at the first sampling.

As described above, the innovative codebook 118 may contain (and output) a set of pulse combinations 710 defined at the second sampling, e.g. at the second sampling rate lower than the first sampling rate at which the output audio signal 702 is rendered.

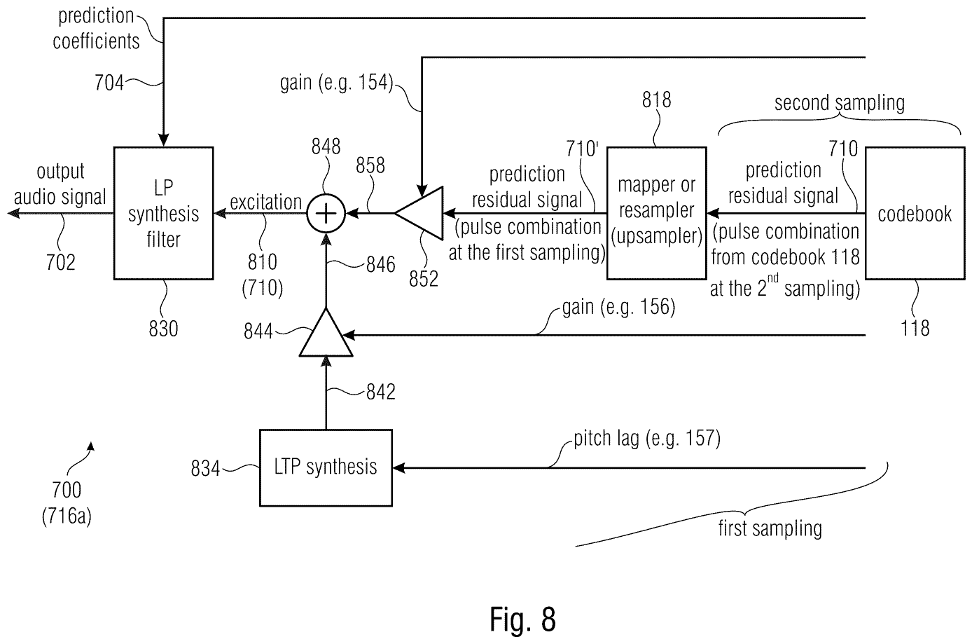

FIG. 8 shows an example of how the prediction coefficients 704 and the prediction residual signal 710, obtained from the codebook 118, may be processed. This may be carried out, for example, partially in the signal processor 703 and/or partially in the pulse information decoder 716. As shown by FIG. 8, the output audio signal 702 is obtained from a LTP synthesis filter 830. The LTP synthesis filter 830 may be defined by the prediction coefficients 704 e.g. as decoded by the prediction coefficients decoder 705. The LTP synthesis filter 830 may be excited by the excitation signal 810. The excitation signal 810 may be obtained, at adder block 848, as a sum between a predictive component 856 and an innovative component 858. The innovative component 858 may be obtained from the prediction residual signal 710 (pulse combination from codebook 118). The prediction residual signal 710 may be scaled, for example, by a gain (e.g. obtained from the gain information 154 written in the other information 117 of the coded signal 124). The result of the scaling at 852 may therefore be the innovative component 858 of the excitation signal 810. The predictive component 846 may be obtained from a LTP synthesis 834 which may include, for example, an adaptive codebook (none shown). The output of the LTP synthesis 834 may be the signal 842. The LTP synthesis 834 may use, as usual, a pitch lag (e.g. obtained from the pitch lag information 157 encoded in the other information 117 written in the coded signal 124). The signal 842 may be scaled at scaler 844 by a gain (e.g. as obtained from the gain information 156 as obtained from the other information 117 written in the coded signal 124). Therefore, the innovative component 846 of the excitation is obtained. The excitation 810 may therefore be obtained as a sum between the components 846 and 858 at adder 848.

A mapper or resampler (e.g. upsampler) 818 may be used to convert the prediction residual signal as outputted by the innovative codebook 118 from its second-sampling version 710 onto its first-sampling version 710′. In the case of using the first alternative (e.g. corresponding to FIGS. 5 and 6), block 818 is a mapper which inserts a void track interleaved with the other tracks (e.g. passing the frame or subframe from the second number of sample positions, e.g. 64, to the first number of sample positions, e.g. 80). In the case of using the first alternative (e.g. corresponding to FIGS. 3a and 3b), block 818 may be a resample (upsampler) which may be similar to the upsampler 318b (in any of its embodiments). In any case, the prediction residual signal 710′ obtained from the mapper or upsampler 818 is at the first sampling (similar, in some examples, to the other signals 858, 846, 842, 810 and 702), while the version 710 of the pulse combination upstream to the mapper or upsampler 818 is at the second sampling. It is to be understood that the mapper or upsampler 818 may be indifferently part of the signal processor 703 or the pulse information decoded 716, and the same applies, in some examples, to the elements 834, 844, 852 and 848.

In the case of the second alternative, at the decoder 700 the resampler 818 (upsampler) may perform an upsampling of the decoded pulse combination, or the processed version thereof, to obtain an upsampled decoded pulses combination at the first sampling; this may be used to update an adaptive codebook (not shown in FIG. 8, but which could be interposed between the upsampler 818 and the scaling at 852). The adaptive codebook may therefore be at the first sampling.

In any case, the upsampler 818 may upsample the decoded combination of pulses 710, or the processed version thereof, in time domain, from the second sampling to the first sampling. In alternative, upsample the decoded combination of pulses 710, or the processed version thereof, in frequency domain (e.g. after having converted from time domain into frequency domain, and, in some examples, subsequently reconverting the frequency-domain upsampled version onto time domain, for example), from the second sampling to the first sampling. In the last case, the upsampler 818 may upsample (from the second sampling to the first sampling) the decoded combination of pulses 710, or the processed version thereof, in frequency domain using a block transform without overlapping between adjacent blocks or using a block transform and zero padding of the spectrum.

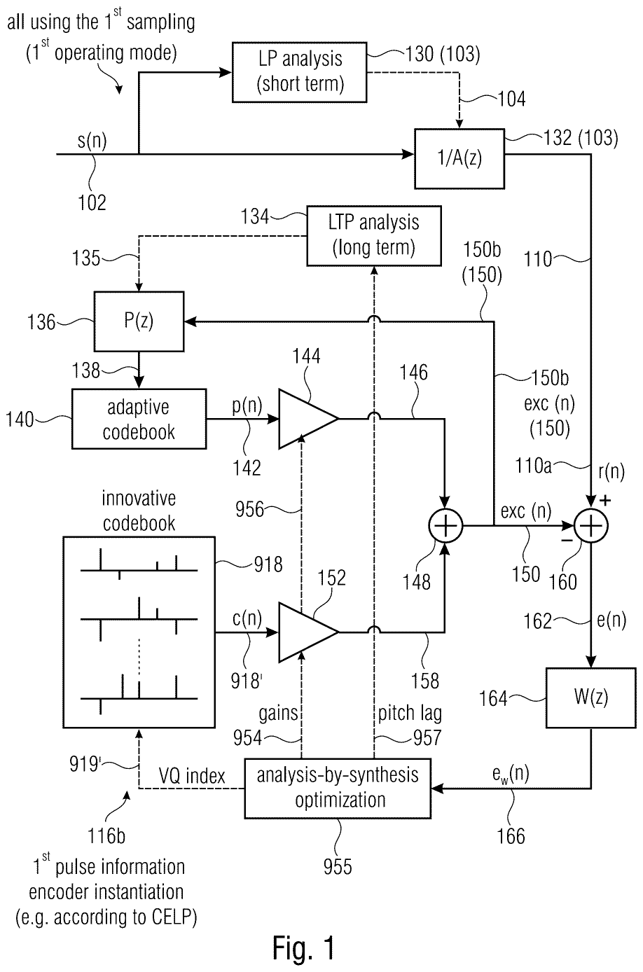

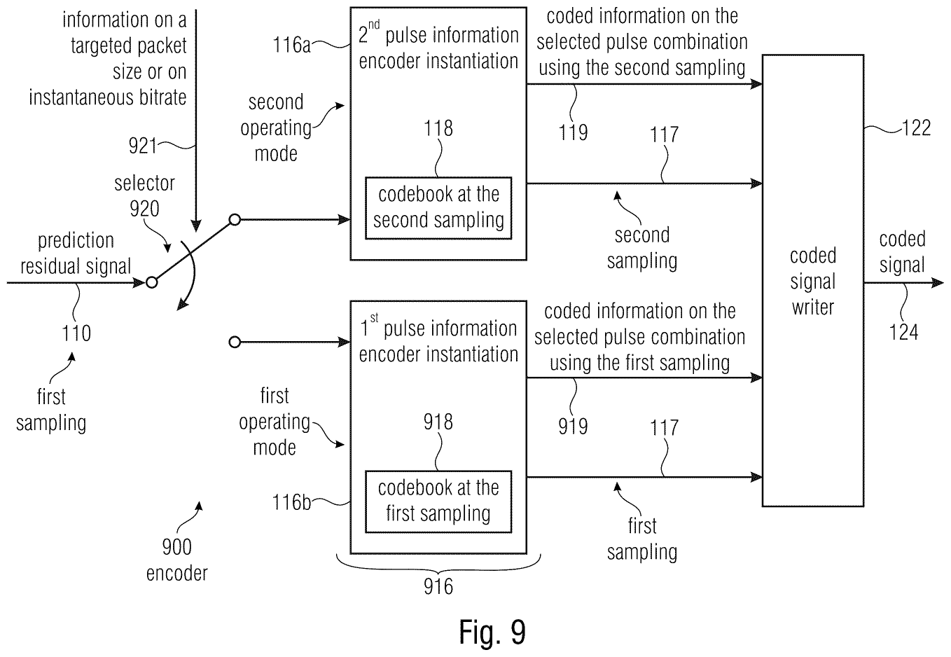

FIG. 9 shows an example of an encoder 900 which may comprise functionalities of the encoder 400. Here, there are not shown the signal processor 103, the prediction coefficients 104, the prediction coefficients encoder 105, because the attention is directed to the evolution of the prediction residual signal from its uncompressed version 110 towards its coded version 119 or 919. It is possible to select (e.g., through the selector 920) between a first operative mode and a second operative mode. The pulse information encoder 916 is selectably instantiated between a first pulse information encoder instantiation 116b (in case of first operative mode being selected) and a second pulse information encoder instantiation 116a (in case of second operative mode being selected). The second operative mode operates as in any of FIGS. 4, 3a, 3b, 5 and 6, and its operations are therefore not re-described. In the second operating mode, the role of the pulse information encoder 116 of FIG. 4 is taken by the second pulse information encoder instantiation 116a, which uses the same codebook 118 of FIG. 4, operating at the second sampling. The outputs 119 and 117 are the same of the respective outputs 119 and 117 of FIG. 4. However, the second operating mode (and the second pulse information encoder instantiation 116a) is selectably deactivatable. Through the selector 920, in fact, it is possible to select a first pulse information encoder instantiation 116b which permits to process according to the first operating mode. In the second mode, there is no resampling and no conversion from the first sampling to the second sampling or vice versa. Simply, in the first operating mode there is used a codebook 918 (e.g. innovative codebook and/or algebraic codebook) which permits to provide the coded information on the selected pulse combination, but at the first sampling. Therefore, in the first operating mode the coded information 919 (coded pulse position information) on the selected pulse combination is not obtained like in FIG. 4, but is obtained like in FIG. 1 (e.g., according to traditional CELP). In general terms, the length of the coded information 919 may be greater than the coding information 119 at the second operating mode. Therefore, the coded information 919 obtained at the first operating mode may be understood as having in general a better quality, despite requiring more bits to be encoded. On the other side, the coded information 119 according to the second operating mode has a slightly reduced quality, but requires less bits. The selection through the selector 920 may be based on information on a targeted packet size or on an instantaneous bitrate (referred to by numeral 921 in FIG. 9). Notably, the sampling of the prediction residual signal 110 remains the same (at the first sampling), but in the second operating mode the coded information 119 is provided at the second sampling (saving bits) and at the first operating mode the coded information 919 is at the second sampling, increasing quality.

The operations of the first pulse information encoder instantiation 116b (operating at the first sampling) is illustrated in FIG. 1 and may be, therefore, according to a CELP encoder. As can be seen by comparing FIG. 1 (representing the first instance 116b) with FIG. 6 (also representing the second instance 116a), in FIG. 1 there is not the mapper 118a, while the analysis-by-synthesis 955 of optimization does not provide a reduced-format entry to the innovative codebook 918 (e.g., there is not a void track, but all the tracks are used). The innovative codebook 918 is in the first sampling and there is no part in FIG. 1 which is according to the second sampling. Of course, even in the cases in which the second operating mode is according to the second alterative (e.g., implying the downsampling, like in FIGS. 3a and 3b) the first pulse information encoder instantiation 116b remains identical to that of FIG. 1.

As can be seen, FIG. 1 has basically the same elements of FIG. 6 with some exception: the analysis-by-synthesis optimization block 955 of FIG. 1 does not provide candidate indexes 119′ in the second sampling, but instead candidate indexes 919′ in the first sampling (i.e., the same of the input signal 102 and the signals 110 and 166); innovative codebook 918 of FIG. 1 is in the first sampling (and not in the second sampling like the innovative codebook 118 of FIG. 6); the candidate pulse combination 918′ of FIG. 1 is in the first sampling (and not in the second sampling, like the analogous sample combination 118′ of FIG. 6). The gain 954 applied to the candidate sample combination 918′ is obtained using the first sampling, and also the gain 956 to be applied to the predictive signal 142 is obtained using the first sampling, as well as also the pitch lag 957 is obtained using the first sampling. Apart from that, and keeping into account that the mapper 118a is missing, the operations in FIG. 1 and in FIG. 6 are the same.

Basically, when operating in the first operating mode (and using the first pulse information encoder instantiation 116b), no track is a void track, but also track 5 of FIG. 5 is taken into account by the innovative codebook 918. When in the first operating mode, therefore, there is the possibility of encoding more pulses and therefore a better quality is achieved. Notwithstanding, the selection at 920 between the first operating mode and the second operating mode may permit to better adapt to the target packet size and/or the instantaneous bitrate.

It is also noted that the selection at 920 between the first operating mode and the second operating mode reduces transitory negative effects, and the prediction residual signal 110 is provided at the same first sampling.

A decoder 1000 is shown in FIG. 10, which correspond to the encoder 900 of FIG. 9. The pulse information decoder 1016 includes a first pulse information decoder instantiation 717b (selectable in case of selection of the first operating more) and a second pulse information decoding instantiation 716a (selectable in case of selection of the second operating more). The decoder 1000, in the second operating mode, may operate exactly like the decoder 700 of FIG. 7, while in its first operating mode may operate without using the second sampling at all, and may be identical, in some examples, to resemble a traditional CELP decoder. Here, the coded signal 124 is read by the coded signal reader 722 and a selection may be operated at 1020 among the first operating mode and the second operating mode. At the second operating mode, the second pulse information decoder instantiation 716a is provided with the coded information 119 and 117 (while the first pulse information decoder instantiation 716b is deactivated), so that the prediction residual signal 710, 710′ is obtained (e.g., like in FIG. 8) by using the innovative codebook as the second sampling 118. However, if the encoded input signal 124 includes the coded information 909 on the selected pulse combination using the first sampling, then the first operating mode is activated and the first pulse information decoder instantiation 716b is activated (while the second pulse information decoder instantiation 716a is deactivated). In the first operating mode, a codebook 918 at the first sampling is used, similarly to traditional CELP decoders. The prediction residual signal as provided by the first pulse information decoder instantiation 716b is indicated with 1010. In any case, both the prediction residual signal 710 (710′) and 1010 is provided to the signal processor 703, to obtain the output audio signal 702. Basically, the first pulse information decoder instantiation 716b may operate almost identically to when operating in the second operating mode: the operations may be identical to those of FIG. 8 with the exception that the second-sampling codebook 118 is substitute by the first-sampling codebook 918 and there is no mapper or resampler 818.

### Discussion of the Present Technique

### First Alternative/Aspect

In the first alternative of the present technique (e.g., FIGS. 5 and 6), the problem of encoding an optimal number of pulse positions is solved by introducing interleaved positions not defined in the codebook 118. These interleaved positions organized in void tracks, are not defined in the codebook 118, which can be on consequence tailored more freely in order to have a size of a power of 2 and/or the desired number of pulses. In other words, possible positions in a frame or subframe are excluded from the codebook 118 such that the number of remaining positions is a power of 2. The so-defined codebook 118 and associated codevectors (e.g. 119′) are then mapped to the sampling used in the encoder 400 by inserting one or several void tracks corresponding to positions not defined in the codebook 118. The constrained codebook 118 is used to position the pulses during the pulse search, while the mapped codebook/codevectors are used for evaluating the performance in the optimization process (e.g. along the iterations of cycle 179 in FIG. 6), so that the additional constraint in the code-building is taken into account.

Example of potential positions of individual pulses in the 8 pulses algebraic codebook using 5 tracks of 16 positions, for a 80 sample subframe:

| Track | Pulses | Positions |
|---|---|---|
| 1 | 0, 4 | 0, 5, 10, 15, 20, 25, |
| | | 30, 35, 40, 45, 50, |
| | | 55, 60, 65, 70, 75 |
| 2 | 1, 5 | 1, 6, 11, 12, 21, 26, |
| | | 31, 36, 41, 46, 51, |
| | | 56, 61, 66, 71, 76 |
| 3 | 2, 6 | 2, 7, 12, 17, 22, 27, |
| | | 32, 37, 42, 47, 52, |
| | | 57, 62, 67, 72, 77 |
| 4 | 3, 7 | 3, 8, 13, 18, 23, 28, |
| | | 33, 38, 43, 48, 53, |
| | | 58, 63, 68, 73, 78 |
| 5 | No | 4, 9, 14, 19, 24, 29, |
| | pulse | 34, 39, 44, 49, 54, |
| | | 59, 64, 69, 74, 79 |

In the above example, with a budget of 8 pulses/subframe, the pulses are distributed unevenly, discarding one track. It is way of resampling the possible position by dropping every 5^{th} position.

### Second Alternative/Aspect (FIGS. 3a and 3b)

Another way to keep small innovative codebook 118 at higher sampling rate is to decimate (or more in general reduce, e.g. downsample) the reachable positions of the codebook (as done in first aspect) and to resample (upsample) it using conventional signal processing resampling techniques. In this sense, the number of positions defined by the codebook 118 can be reduced and the number of pulses increased for a given bit budget. Similarly to the first aspect of the technique, the pulses can be positioned in the reduced number of positions defined by the codebook 118, while the optimization can be done after resampling (upsampling) the codevector to evaluate. However it may engender a high complexity overhead, since resampling is costly especially if done for each codevector candidate to evaluate. As an alternative and in the preferred embodiment, the optimization process, or part of it, is performed in the sampling of the codebook 118 by resampling (downsampling, 310a in FIG. 3a) the target signals 110 and impulses responses necessary for the optimization (e.g. at the first step of FIG. 3a). Only the so-obtained optimal codevector 118″ will be then be resampled (upsampled, 318b in FIG. 3b) to the sampling of the coder for the subsequent processes (e.g. the second step of FIG. 3b).

For example, the resampling at 318b and/or 310a can be done using Linear filtering, having low-pass characteristics. However, linear filtering has the disadvantage to engender delay. Non-delay linear filters, like IIR, has the disadvantages to have non-linear phase, which is problematic for pulse-like signals. In the preferred embodiments, frequency domain resampling, involving circular convolution is used. The codebook 118 may be resampled at 318b preferably in the frequency domain using no, or some zero-padding, to reduce the number of possible positions for the pulses to position.

### EXAMPLES

Encoder:
Target signal->FFT 80 samples->truncation [scaling]->IFFT 64 samples->search in innovative codebook on 4 tracks of 16 samples
Decoder:
innovative codevector on 4 tracks of 16 samples->FFT 64 samples->resampling with zero addition and/or spectrum replication like copy-up/mirroring [scaling]->FFT 80 samples

The proposed techniques can combine lower number of pulses for innovative codebook 118 and relatively high sampling-rate, on which the speech coder (CELP) operates.
Important aspects are: Speech coder operating at a first sampling-rate using linear prediction(s), wherein the residual of at least one prediction is coded by positioning:
   Pulses at given possible positions,
   Wherein the possible positions are a subset or a resampled version of the positions possible at the first sampling-rate.
the subset of the positions at the first sampling-rate may be obtained by skipping regular position of the positions at the first sampling-rate
the possible positions are obtained by resampling vectors of codebooks from the first sampling-rate to a given sampling rate.

A main, non-limiting example is principally about enhancing CELP (Code-Excited Linear Prediction), which an efficient speech coding scheme used to compress and transmit speech signals efficiently while maintaining a reasonably high quality.

The original speech 102 given as input may be represented as a combination of linear predictions and excitation modeling, aka linear prediction residual coding. The speech signal may be divided into short frames and/or subframes, e.g. ranging from 5 to 20 milliseconds. Within each frame or subframe, CELP performs analysis and encoding to extract the parameters necessary for synthesis at the receiver's end. The CELP encoding process comprises the following steps:

### Pre-Processing

The input speech signal is divided into frames and/or subframes, and eventually resampled and high-pass filtered to remove the DC bias. The signal can also be pre-emphasized in high frequencies for compensating the natural negative frequency tilt (i.e. much more energy in low-frequencies in present than in the high end), which prevents analyzing accurately the high frequency content through a linear prediction. Each frame or subframe is then processed individually by keeping filter memories updated for smoothing transitions. Some analyses, like short-term prediction analysis, aka Linear Prediction Coding analysis (LPC analysis), use windows for a better and more accurate analysis.

### LP(C) Analysis (Short-Term) and Quantization

The LPC analysis 130 and quantization are performed once or twice per frame or subframe using the autocorrelation approach with an analysis window of about 30 ms. Windows can symmetric or asymmetric windows depending of the delay constrain and have lookahead relative to the current frame or subframe considered for the coding. A lookahead of 5 ms and 8.75 ms is usually acceptable for speech communication The Levinson-Durbin recursion can compute the optimal LPC prediction parameters based on computed autocorrelation function. The so-obtained prediction coefficients can be efficiently coded by vector quantizing the corresponding Linear Spectral Frequencies.

### LPC (Analysis) Filler

The short-term prediction is performed through the LPC analysis filter 1/A (z) (132), using the quantized coefficients available at the decode side as well. The residual is then moduled using the LTP and fixed codebook 118.

### LTP Analysis (134)

The long-term prediction relies mainly on the pitch lag estimation, pitch lag which has a direct correspondence with the fundamental frequency f0, or main periodicity, of the signal 102. It can be estimated with auto-correlation function, by considering much longer order/lag than LPC for covering the expected range of pitch at given sampling-rate. It will be served for the long-term prediction used in the subsequent processing.

### Long-Term Prediction

The long-term prediction (LTP) may be used through the adaptive codebook 140. The adaptive codebook 140 may contain past coded excitation vectors that are adapted for every frame or subframe. The adaptive codebook 140 may be derived from the long-term prediction parameter 135, the pitch lag 157, which can be viewed as an index into the adaptive codebook 140. The LTP may then be applied backward, i.e. in sync between the encoder and decodes sides.

### Innovation Coding-Pulse Search in Fixed Codebook

The residual of the two predictions LPC and LTP may then be modeled by the fixed (innovative) codebook 118. The fixed codebook 118 may contain non-adaptive excitation vectors (i.e. fixed) for modeling the residual of the predictions. The selected codevector is also called the innovation, and will in addition to the adaptive codebook contribution 142 excites the LPC synthesis filter 830 at decoder side. The fixed codebook 118 for complexity and memory reasons often comprises algebraic codes, which may contain a small number of nonzero pulses with predefined interlaced sets of potential positions (the tracks). The amplitudes and positions of the pulses of a codevector can be derived solely from its index through algebraic rule requiring no or minimal memory storage, unlike look-up tables as used in classical stochastic vector quantization. It is this fixed codebook 118 which the main subject of the present technique. Indeed, the fixed codebook 118 is usually designed at the sampling-rate of the signal accepted by the CELP coder. At very low bit-rate, only few pulses can be positioned if all positions at the input sampling rate is considered. Therefore, CELP designed for very low bit-rate needs to reduce its sampling rate, as for example using 12.8 kHz instead 16 kHz for modeling Wide-band signals. It has the negative effect of reducing the coded audio bandwidth or require the use of a complementary band extension module, which is globally suboptimal and structurally complex. The propose of the technique is to keep the input sampling rate high, like 16 kHz, and design specific fixed codebook for being able to reach very low bit-rates.

The codebook structure may be based on interleaved track positions (e.g. in the examples of FIGS. 5 and 6). For example, for 5 ms subframe at 16 kHz, the 80 positions in the code vector are divided into 5 equally sized tracks of interleaved positions, with 16 positions in each track. The different codebooks (e.g. 118 and 918) at the different rates may be constructed by placing a certain number of signed pulses in the tracks, from 1 to up 8 or 10 pulses per track depending of the bit budget available.

For achieving even lower bit-rate the current technique proposed two solutions:
To relax (like in FIGS. 5 and 6) the constrain of having at least one pulse per track, and to allow having a track not populated by a pulse. Leaving out one track means decimating (or otherwise reduced) the positions reachable by the codebook, and allow the coding to be more efficient since lowering the number of possible positions, i.e. the number of bits required. In this way a higher number of pulses can be maintained compared to the conventional approach at the cost of less flexibility in the positioning of the pulses, which is in general a better compromise at very low bit-rate.
The second solution (FIGS. 3a and 3b) includes performing a proper downsampling e.g. involving Low-pass filtering, only for the fixed codebook contribution. It can be achieved using time filters like linear phase FIR filters or other linear interpolation. In order to reduce possible delays, there are preferred techniques like using resampling in frequency domain, using rectangular windows, truncation (for downsampling) and zero-padding (for upsampling), in the frequency domain, which correspond to a resampling using circular convolution. The use of circular convolution in association with rectangular window is also advantageous especially in the LPC and LTP residual domain where the signal highly whitened.

At the decoder side, the CELP decoding process reverses the encoding steps to reconstruct the speech signal 102 as the output signal 702. The decoder 700 may use the received bitstream 124 to synthesize the speech signal 702 by applying inverse linear prediction, reconstructing the excitation signal 810, and finally combining them to obtain the reconstructed speech 702.

Remapping of Fixed Codebook 118 (e.g. FIGS. 5 and 6)

More description is needed there.

Coded pulse information & codebook 118 defined at a second sampling, where possible positions for the pulses is shared with the first positions of samples defined at the first sampling, used by the rest of the coder. A mapping (e.g. at mapper 118a of FIG. 6) is then used which may insert a void track to the coded pulses (FIGS. 5 and 6).

Resampling of Fixed Codebook (e.g. FIGS. 3a and 3b)

FIGS. 3a and 3b show that the CELP gain optimization (second step in FIG. 3b, cycle 179b) may use the upsampled coded pulses 318b″ at the first sampling (fs_1), although the pulse search is done (at the first step in FIG. 3a, cycle 179a) at the second sampling (fs_2).

FIGS. 3a and 3b refers to a second aspect of the technique. FIG. 3a: optimization of the pulse search using optimal gain done at the second sampling-rate fs_2. FIG. 3b: Gain quantization done after getting the selected pulse combination, and optionally shaping it with filter S_2(z), and upsampling the coded and eventually processed pulse combination from fs_2 to fs_1

### Remarks/Definitions which May Apply in Some Examples

$$Sampling - rate = number of samples within a duration ( e . g . in 1 s or in a frame and / subframe )$$

$$Sampling = sampling - rate + sample positions ( the positions are part of discretization properites )$$

### Further Examples

Generally, examples may be implemented as a computer program product with program instructions, the program instructions being operative for performing one of the methods when the computer program product runs on a computer. The program instructions may for example be stored on a machine readable medium.

Other examples comprise the computer program for performing one of the methods described herein, stored on a machine readable carrier. In other words, an example of method is, therefore, a computer program having a program instructions for performing one of the methods described herein, when the computer program runs on a computer.

A further example of the methods is, therefore, a data carrier medium (or a digital storage medium, or a computer-readable medium) comprising, recorded thereon, the computer program for performing one of the methods described herein. The data carrier medium, the digital storage medium or the recorded medium are tangible and/or non-transitionary, rather than signals which are intangible and transitory.

A further example of the method is, therefore, a data stream or a sequence of signals representing the computer program for performing one of the methods described herein. The data stream or the sequence of signals may for example be transferred via a data communication connection, for example via the Internet.

A further example comprises a processing means, for example a computer, or a programmable logic device performing one of the methods described herein.

A further example comprises a computer having installed thereon the computer program for performing one of the methods described herein.

A further example comprises an apparatus or a system transferring (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some examples, a programmable logic device (for example, a field programmable gate array) may be used to perform some or all of the functionalities of the methods described herein. In some examples, a field programmable gate array may cooperate with a microprocessor in order to perform one of the methods described herein. Generally, the methods may be performed by any appropriate hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] 3GPP, ETSI TS (1) 26.441, “EVS Codec: General Overview,” ver. 12, rel. 12, October 2014.
[2] 3GPP, ETSI TS (1) 26.445, “EVS Codec: Detailed algorithmic description,” May 2022.

1. An apparatus for generating a decoded audio signal divided into a plurality of frames or subframes according to ACELP, comprising:
a coded signal reader configured to read at least, from a coded signal, coded information on prediction coefficients and coded information on at least one pulse;
a signal processor configured to generate the decoded audio signal from at least a decoded version of the prediction coefficients and a decoded pulse combination, or the processed version thereof, wherein the decoded audio signal is generated at a first sampling, the first sampling implying, in one frame or subframe, a first plurality of sample positions having a first number of sample positions;
wherein the apparatus is configured to derive the decoded pulse combination from the coded information on the at least one pulse and a second-sampling codebook, wherein the at least one second-sampling codebook comprises a set of pulse combinations defined at a second sampling, the second sampling implying, in the frame or subframe, a second plurality of sample positions having a second number of sample positions, wherein the first sampling is different from the second sampling at least in that the first plurality of sample positions is different from the second plurality of sample positions,
wherein the second number of sample positions is smaller than the first number of sample positions, wherein the at least one second-sampling codebook is or includes an innovative codebook.

2. The apparatus of claim 1, configured to use the decoded pulse combination, or the processed version thereof, to excite a synthesis filter derived from the prediction coefficients.

3. The apparatus of claim 1, wherein the coded signal reader is configured to read coded information about a long-term prediction, related to a prediction lag and/or to at least one long-term prediction gain, and wherein the apparatus is configured to generate the decoded audio signal based on a long-term prediction using the prediction lag and/or the at least one long-term prediction gain.

4. The apparatus of claim 1, configured so that the first plurality of sample positions and second plurality of sample positions within the frame or subframe are defined by a first plurality of tracks and a second plurality of tracks, respectively, regularly interleaved with each other, where the second plurality of sample positions is defined by at least one track less than the first plurality of sample positions.

5. The apparatus of claim 4, configured to process the decoded pulse combination by inserting at least one void track with zero-valued samples regularly interleaved in the second plurality of tracks, to thereby obtain resampled decoded pulse combination at the first sampling, the resampled decoded pulse combination being defined at the first plurality of sample positions.

6. The apparatus of claim 4, wherein the first plurality of tracks and the second plurality of tracks of the first plurality of sample positions and the second plurality of sample position, respectively, have the same sample positions each, apart from the at least one void track.

7. The apparatus of claim 4, wherein the second plurality of sample positions is mapped to be the first plurality of sample positions, by adding at least one void track to the tracks of the second plurality of tracks.

8. The apparatus of claim 1, configured to resample the decoded pulse combination, or the processed version thereof, from the second sampling to the first sampling, to obtain a resampled version of the coded pulse combination, or the processed version thereof.

9. The apparatus of claim 1, further comprising a resampler configured to resample the decoded pulse combination from the second sampling to the first sampling for processing further the decoding.

10. The apparatus of claim 1, further comprising a resampler configured to perform an upsampling of the decoded pulse combination, or the processed version thereof.

11. The apparatus of claim 1, configured to select between the at least first operating mode and second operating mode depending on a targeted packet size or the instantaneous bit-rate of the present frame to encode.

12. The apparatus of claim 1, configured to receive a gain from the coded signal and to apply the gain to the decoded pulse combination.

13. An apparatus for encoding an audio signal divided into a plurality of frames or subframes according to ACELP, the apparatus comprising:
a signal processor configured to determine prediction coefficients and a prediction residual signal in time domain at a first sampling, the first sampling implying, in one frame or subframe, a first plurality of sample positions having a first number of sample positions;
a pulse information encoder configured to determine coded information on a selected pulse combination which represents the prediction residual signal, the selected pulse combination being one entry of at least one second-sampling codebook, wherein the at least one second-sampling codebook comprises a set of pulse combinations defined at a second sampling, the second sampling implying, in the frame or subframe, a second plurality of sample positions having a second number of sample positons, wherein the first sampling is different from the second sampling at least in that the first plurality of sample positions is different from the second plurality of sample positions, wherein the second number of sample positions is smaller than the first number of sample positions; and
a coded signal writer configured to write at least a coded information on the prediction coefficients and the coded information on the selected pulse combination.

14. The apparatus of claim 13, configured to define the first plurality of sample positions and the second plurality of sample positions within the frame or subframe as a first plurality of tracks and second plurality of tracks, respectively, regularly interleaved with each other, where the second plurality of sample positions is defined by at least one track less than the first plurality of sample positions.

15. The apparatus of claim 13, configured to define the first plurality of sample positions according to a first plurality of tracks regularly interleaved with each other, wherein at least one void track among the first plurality of tracks is ignored by the at least one second-sampling codebook, so that the second plurality of sample positions is formed by the sample positions defined by the first plurality of sample positions which are not in the at least one void track.

16. The apparatus of claim 14, configured to define the first plurality of tracks and the second plurality of tracks of the first plurality of sample positions and the second plurality of sample positions, respectively, as having the same sample positions in each track, apart in the at least one void track.

17. The apparatus of claim 14, wherein the second plurality of sample positions is mapped to the first plurality of sample positions, by adding the at least one void track from the first plurality of tracks to the second plurality of tracks.

18. The apparatus of claim 14, wherein the selected pulse combination defined at the second sampling is mapped to the first sampling by adding zero-valued samples at sample positions defined by the void track of the first plurality of tracks, which is not defined in the second plurality of tracks.

19. The apparatus of claim 13, configured to downsample the prediction residual signal, or the processed version thereof, from the first sampling to the second sampling, to obtain a downsampled version of the prediction residual signal or the processed version thereof, so that the pulse combination is searched within the at least one second-sampling codebook considering the downsampled version of the prediction residual signal or processed version thereof.

20. The apparatus of claim 13, further comprising an upsampler configured to upsample the selected combination of pulses from the second sampling to the first sampling for processing further the encoding.

21. The apparatus of claim 20, wherein the upsampled selected combination of pulses is used for updating an adaptive codebook and/or for determining a coded gain.

22. The apparatus of claim 13, further comprising a resampler configured to resample another signal(s) or impulse response(s) needed for the search within the at least on second-sampling codebook.

23. The apparatus of claim 13, configured, in a first step, to search the pulse combination in the second sampling, and, once the selected pulse combination is found, configured, in a second step, to search the gain for the selected pulse combination in the first sampling, using an upsampled version of the selected pulse combination.

24. The apparatus of claim 13 configured to convert the prediction residual signal or the processed version thereof, or the selected combination of pulses, or the processed version thereof, into frequency domain and downsample the prediction residual signal or the processed version thereof, and/or upsample the selected combination of pulses, or the processed version thereof in frequency domain

25. The apparatus of claim 24, configured to downsample the prediction residual signal or the processed version, to upsample the selected combination of pulses or the processed version thereof in frequency domain using a constant scaling.

26. The apparatus of claim 13, wherein the pulse information encoder is configured to compare the prediction residual signal or processed version thereof with a plurality of candidate signals, each of the plurality of candidate signals being obtained from a respective codebook index, the pulse information encoder being configured to select a particular codebook index which permits to obtain a candidate signal which, among the plurality of candidate signals, minimizes an error, or processed version thereof, from the prediction residual signal or processed version thereof.

27. The apparatus of claim 26, the pulse information encoder being configured to select a particular codebook index which permits to obtain a candidate signal which, among the plurality of candidate signals, minimizes an error from downsampled version of the prediction residual signal or processed version thereof, wherein both the plurality of candidate signals and the downsampled version of the prediction residual signal or processed version thereof are at the second sampling.

28. The apparatus of claim 26, the pulse position information encoder being configured to select a particular entry which is associated with a candidate signal which, among the plurality of candidate signals, minimizes the error from the prediction residual signal or processed version thereof, wherein the prediction residual signal or processed version thereof is at the first sampling, and the plurality of candidate signals are at the second sampling, the apparatus comprising an upsampler to convert the selected candidate signal from the second sampling to the first sampling, so as to perform the comparison at the first sampling.

29. The apparatus of claim 28, the pulse position information encoder being configured to scale the selected candidate signal onto a scaled selected candidate signal, so as to compare a candidate signal based on the scaled upsampled selected candidate signal with the prediction residual signal or processed version thereof.

30. The apparatus of claim 29, configured to scale the upsampled selected candidate signal by a plurality of candidate gains, so as to select the gain which contributes to minimize the error, and to encode gain information indicative of the selected gain.

31. The apparatus of claim 13, configured to refrain from signalizing the at least one second-sampling codebook in the coded signal, and to bound its usage to the packet size of the current and/or a coding mode or any other coded information already present in the packet.

32. The apparatus of claim 13, configured to search, among the code combinations of the at least one second-sampling codebook, the selected code combination as the code combination which minimizes an error, or another cost function, between the prediction residual signal and a candidate excitation signal having at least one component obtained from the at least one second-sampling codebook.

33. The apparatus of claim 32, configured to search in one cycle having multiple iterations, by using candidate pulse combinations from the at least one second-sampling codebook, and multiple candidate gains to scale the candidate pulse combinations in the same cycle.

34. The apparatus of claim 33, wherein the at least one second-sampling codebook is configured to output the candidate pulse combinations in the second sampling, and the candidate gains in the first sampling, wherein the apparatus further comprises a mapper to convert, in the same iteration, the candidate pulse combinations from the second sampling to the first sampling.

35. The apparatus of claim 13, configured to perform a first step using the second sampling, to search in a first iterative cycle, among a plurality of candidate code combinations from the at least one second-sampling codebook, the selected code combination as the candidate code combination which, in the second sampling, minimizes an error, or another cost function, between the prediction residual signal and a candidate excitation signal having at least one component obtained from the candidate code combination, and
further configured to perform a second step using the first sampling, to search in a second iterative cycle, using an upsampled version of the selected code combination in the first sampling a gain among a plurality of candidate gains, which minimizes an error, or another cost function, between the prediction residual signal and a candidate excitation signal having at least one component obtained from the upsampled version of the selected code combination scaled by the candidate gain.

36. The apparatus of claim 1, configured to perform an upsampling of the decoded pulse combination, or the processed version thereof, to obtain an upsampled decoded pulses combination or processed version thereof to update an adaptive codebook.
